(19) United States
(12) Patent Application Publication
(10) Pub. No.: US 2010/0025959 A1
(43) Pub. Date: Feb. 4, 2010

(54) Trailer and Jack System

(76) Inventor: John R. Adams, Chico, CA (US)

Correspondence Address: Ken Campbell, P.O. Box 1381, Denver, CO, 80132, US

(21) Appl. No.: 12/185,263

(22) Filed: Aug. 4, 2008

(51) Int. Cl. B60D 1/00

(52) U.S. Cl. 280/400

(57) ABSTRACT

A system for installation and removal of a storage shed is disclosed. The system includes a custom trailer, a specialized storage shed, and a complete set of unique lifting components. The system allows a single operator to conveniently and safely deliver/remove a storage shed, without causing damage to the it in the process.

### BACKGROUND

Transportable storage sheds are not new. Fully assembled storage sheds are normally hauled on bulky trailers, to and from their destination. Upon delivery, sheds are physically slid off of the trailer. Separate leveling equipment, such as jacks, hoists or pry bars must then be used to block and level the shed.

During pick-up, the sheds are usually pulled back onto the trailer with a winch. This repetitive routine often causes damage to the shed, and reduces is useful lifetime. This routine can also damage the delivery site, as well as any contents that may remain in the shed.

This specialized shed installation and removal system allows a single person to deliver a storage shed safely and accurately. The unique construction of the system, lends itself to an extremely efficient and versatile technique, which can prolong the useful life of the shed and make delivery possible in tighter areas.

### SUMMARY OF THE INVENTION

It is an object of the present invention to provide a system of delivery and removal for storage sheds, which allows for access to tighter areas than would otherwise be possible.

It is another object of the present invention to use the same jacks for the leveling and blocking procedure, as well as the delivery and removal process. This allows a single person to deliver and block and level a large all-wood shed without any help.

It is another object of the present invention to provide safe and simple components that are easy to handle, attach, and stow in the towing vehicle. Additionally, some components remain on the shed and actually protect it from damage during transit.

It is another object of the present invention to provide removable braces (outriggers) on the trailer to reduce the trailer's overall weight and width. The narrow trailer (without outriggers) can then be removed from under the shed and clear the front jacks even if the truck is at an angle to the trailer (jackknifed to some degree). In situations where the trailer is at such an angle that it will hit the front jack on the way out, a front jack can be removed and the shed can be blocked or supported by a 4″×6″ or larger timber approx. 24″ to 30″ long or other appropriate blocking. This support would be placed farther back on the skid to allow the trailer to be removed. After the trailer is removed the jack assembly can be re-attached and the shed can be lowered into place. The lightweight trailer design allows it to be moved by hand or by winch, in certain situations. The number of outriggers required can vary with the weight and length of the cargo being hauled.

It is another object of the present invention to provide folding fenders on the trailer, which swing away from the tires and allow the shed to ride much lower on the trailer, creating a lower center of gravity for safe hauling. The shed covers the wheels during transit, and acts as fenders.

### DESCRIPTION OF DRAWING VIEWS

FIG. 1 is a street-level perspective view of the invention.

FIG. 2 is a close-up perspective view.

FIG. 3 is an overhead perspective view of a portion of the jack assembly.

FIG. 4 is an overhead perspective view of a portion of the jack assembly.

FIG. 5 is a close-up perspective view.

FIG. 6 is

FIG. 7 is a close-up perspective view.

FIG. 8 is a street-level close-up view.

FIG. 9 is a street-level view of a portion of the invention.

FIG. 10 is a perspective view of a portion of the invention.

FIG. 11 is a perspective view of a portion of the invention.

FIG. 12 is a street-level close-up view

FIG. 13 is an overhead perspective view of a portion of the invention.

FIG. 14 is a street-level close-up view.

FIG. 15 is a street-level close-up view.

FIG. 16 is a close-up perspective view.

FIG. 17 is a close-up perspective view.

FIG. 18 is a close-up perspective view.

FIG. 19 is a close-up perspective view.

FIG. 20 is a street-level view of the invention.

| Item List | Item numbers |
|---|---|
| SHED | 10 |
| SKID | 11 |
| SKID PROTRUSION | 12 |
| JACK ASSEMBLY | 20 |
| SLIDE COLLAR | 21 |
| OUTER SLIDE COLLAR PIPE | 22 |
| HOOK | 23 |
| FOOT PAD | 24 |
| INNER DOWEL PIPE | 25 |
| LOWER SEGMENT LIFT PIPE | 26 |
| UPPER SEGMENT LIFT PIPE | 27 |
| HOIST | 28 |
| TRAILER | 30 |
| FOLDING FENDERS | 31 |
| OUTRIGGERS | 32 |
| SET BOLT | 33 |
| TIE-DOWN CHAINS | 34 |

### DESCRIPTION OF THE INVENTION

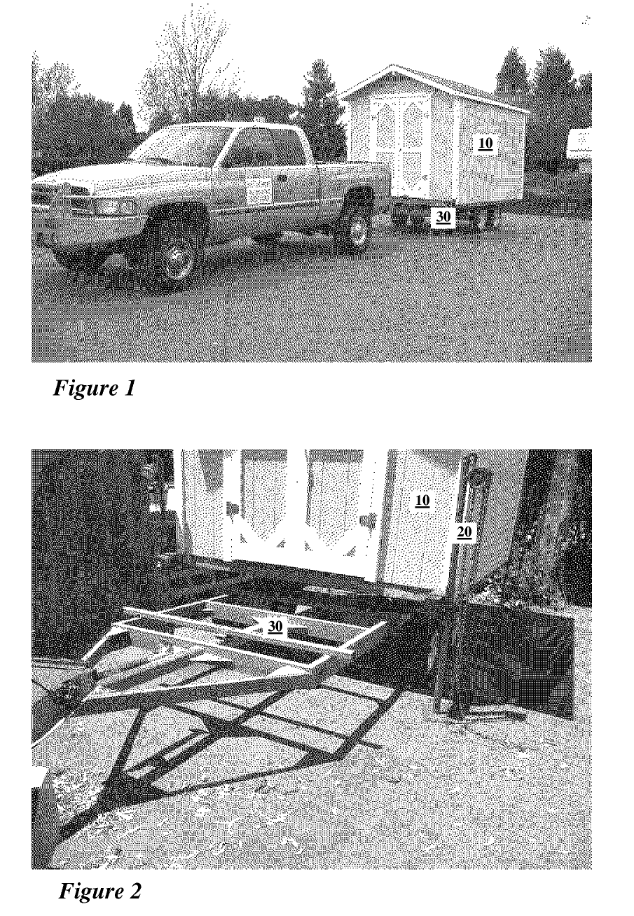

FIG. 1 shows a Shed 10 that has been loaded onto its Trailer 30, appearing so as part of the system that comprises the invention.

FIG. 2 shows the complete system being utilized at once. The Shed 10 has been lifted into loading position and held there with the four Jack Assemblies 20, as the Trailer 30 backs into place.

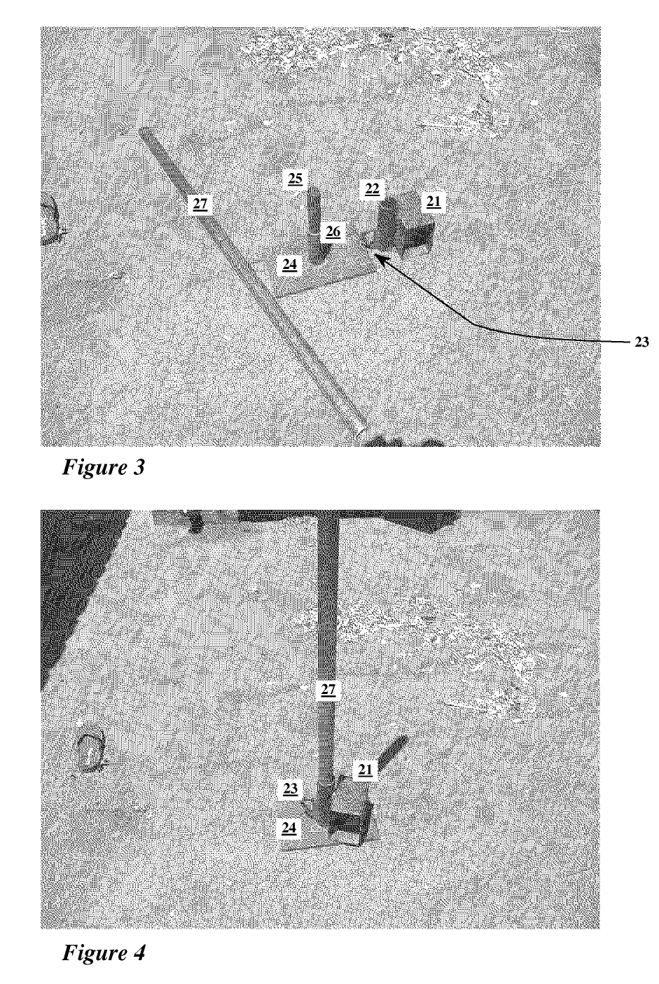

FIG. 3 shows three of the four components of a single Jack Assembly 20: the Slide Collar 21, the Foot Pad 24, and the Upper Segment Lift Pipe 27.

The metal Slide Collar 21 slides over a Skid Protrusions (not shown in this figure) at the base of a specialized Shed (not shown in this figure). They also possess a short Outer Slide Collar Pipe 22 and a Hook 23, which are all welded together as shown.

The metal Foot Pad 24 has a square base welded to an Inner Dowel Pipe 25 and an Lower Segment Lift Pipe 26.

The metal Upper Segment Lift Pipe 27 assembles to the Foot Pad 24 and guides the Slide Collar 21 vertically.

FIG. 4 shows the components listed in FIG. 3, in their assembled state. Here, the Upper Segment Lift Pipe 27 has been assembled onto the Foot Pad 24, and the Slide Collar 21 has been slid thereon. When lifted by the Hook 23, the Slide Collar 21 will be guided up and down the Pipe Assembly.

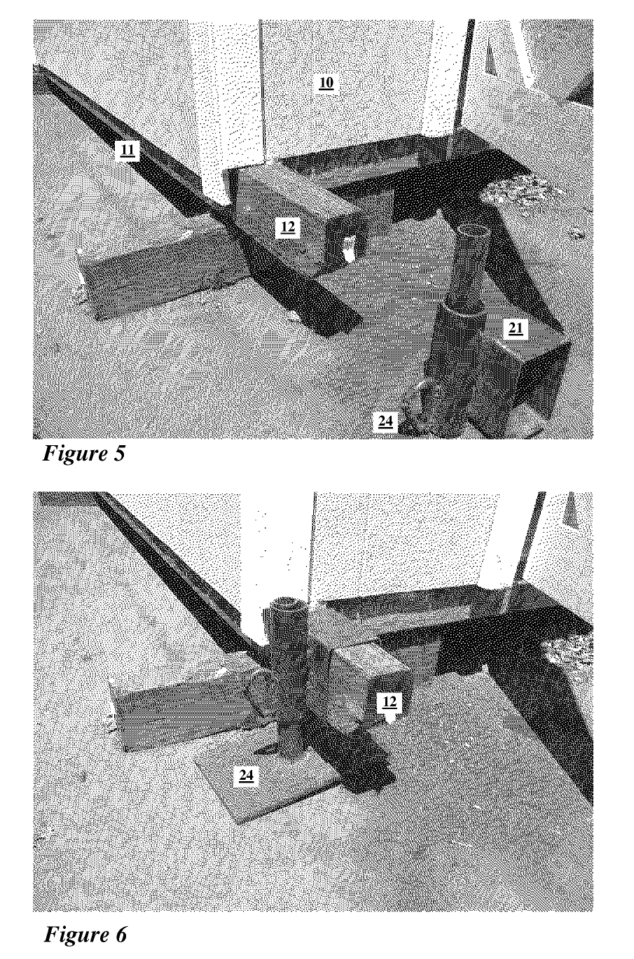

FIG. 5 Shows One Foot Pad 24 and one Slide Collar 21 assembled just prior to mounting onto the Shed 10, which possesses a Skid Protrusion 12 at each corner for mounting the Slide Collars 21. A Skid 11 runs along each side of the specialized Shed 10, at its base.

FIG. 6 shows the foot pad/slide collar assembly of FIG. 5 after it has been mounted onto the Skid Protrusion 12 of the specialized Shed 10.

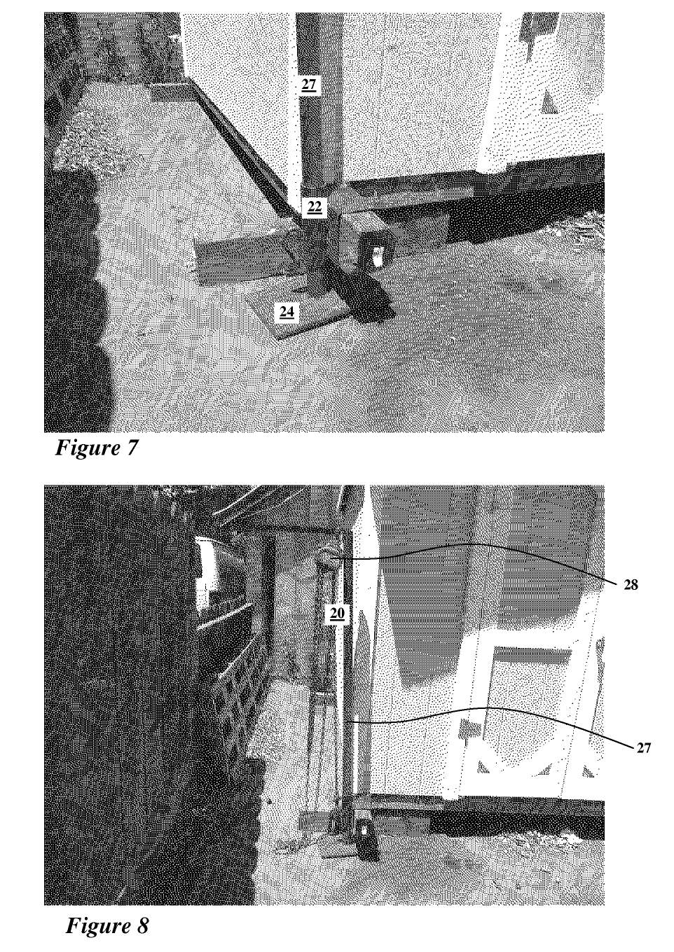

FIG. 7 shows the Upper Segment Lift Pipe 27 in place within the Outer Slide Collar Pipe 22 of the Slide Collar 21, and mounted over the Inner Dowel Pipe (not visible in this figure) of the Foot Pad 24.

FIG. 8 shows one complete Jack Assembly 20, which also includes a Hoist 28. In this case, it is a chain-type hoist. Any appropriate means for hoisting objects can be used. The Hoist 28 hooks into open end at the top of the Upper Segment Lift Pipe 27.

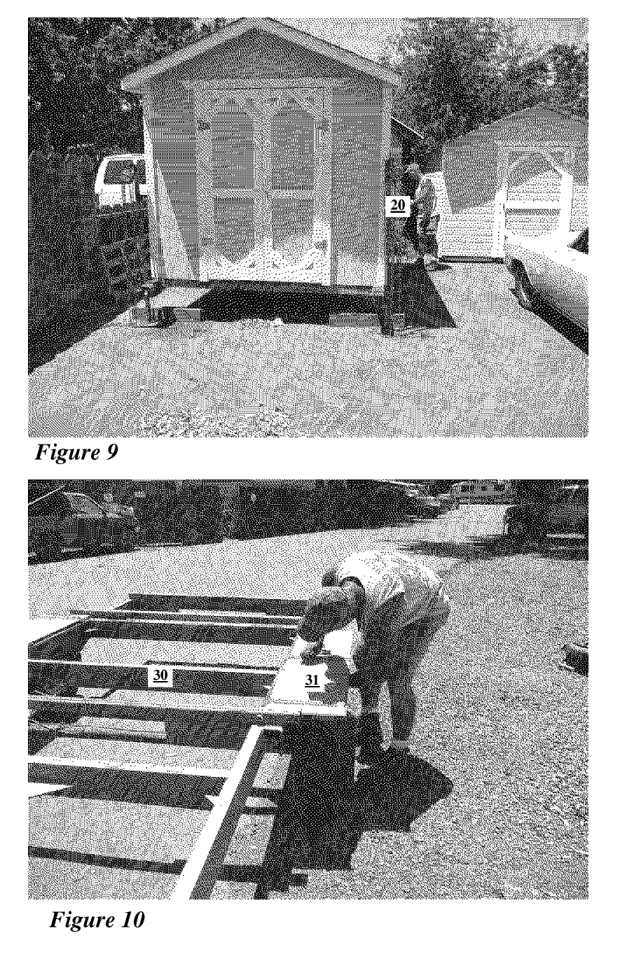

FIG. 9 shows a single operator able to adjust each Jack Assembly 20 incrementally, able to keep the Shed level, and able to gradually raise it high enough for the Trailer. (Four jack assemblies are used at one time, one at each corner of the shed.)

FIG. 10 shows an operator preparing to swing one of the Folding Fenders 31 out of the way. The Trailer 30 is a low-profile, open frame (no decking), tandem-axle unit. The rear frame area is 2-3 feet narrower than the rest of the frame. This helps in the removal of the Trailer from under the lifted shed.

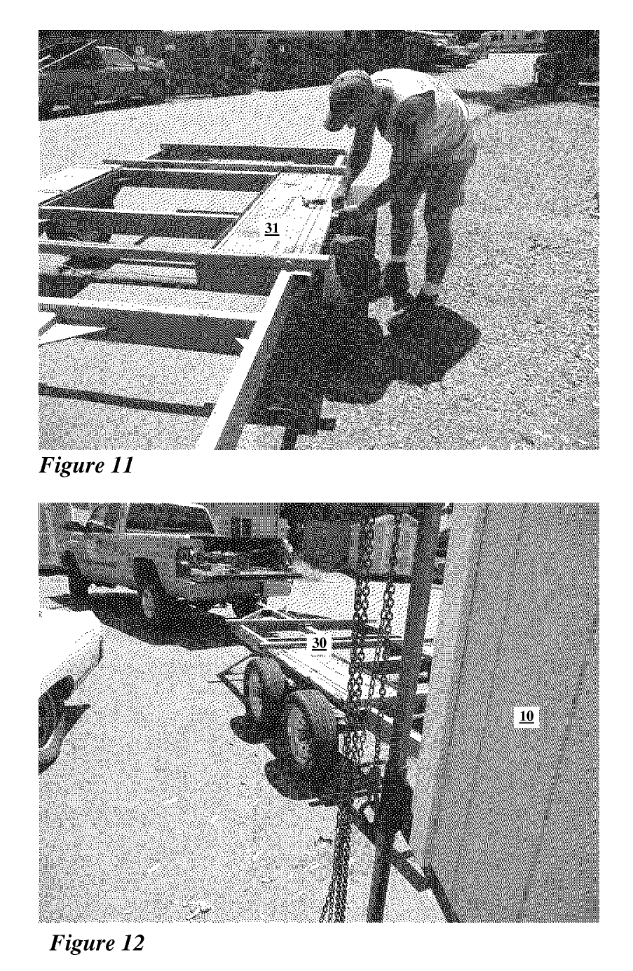

FIG. 11 shows one of the Folding Fenders 31 after it has been moved away from the tires.

FIG. 12 shows the Trailer 30 being backed under the Shed 10, to prepare it for removal.

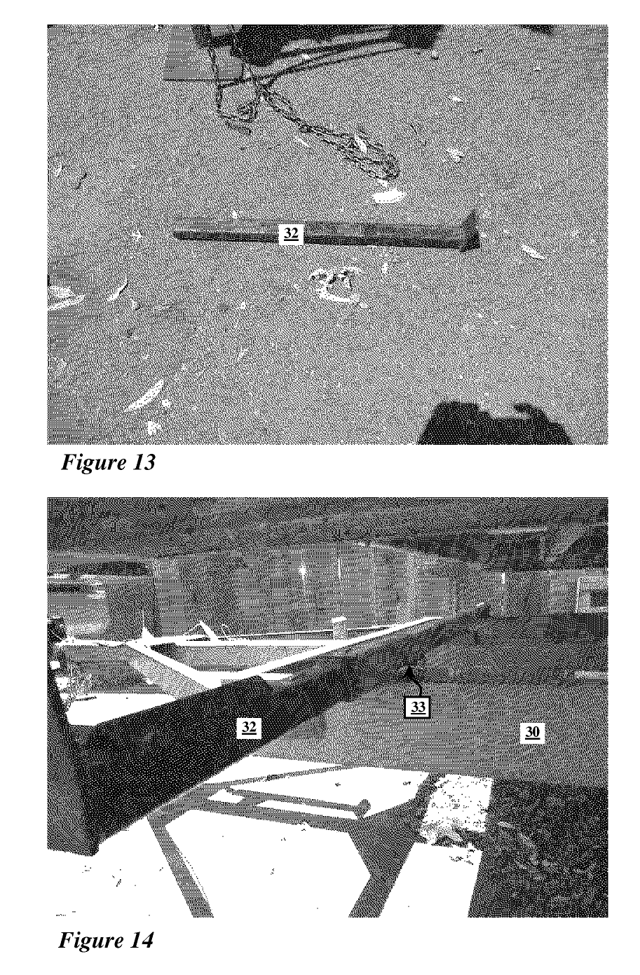

FIG. 13 shows a single metal Outrigger 32, which is made of a square stock piece with an angle piece welded to the outer top portion, and a stop piece welded to the end. (FIG. 14 shows this from a different angle.)

FIG. 14 shows the Outrigger 32 in position, after it has been inserted into the Trailer 30. This figure gives a better view of the angle piece near the outer end of the Outrigger 32, which helps to keep the wooden skid of the shed from sliding forwards and backwards on the trailer. A set bolt is used to secure the Outrigger 32 to the Trailer 30.

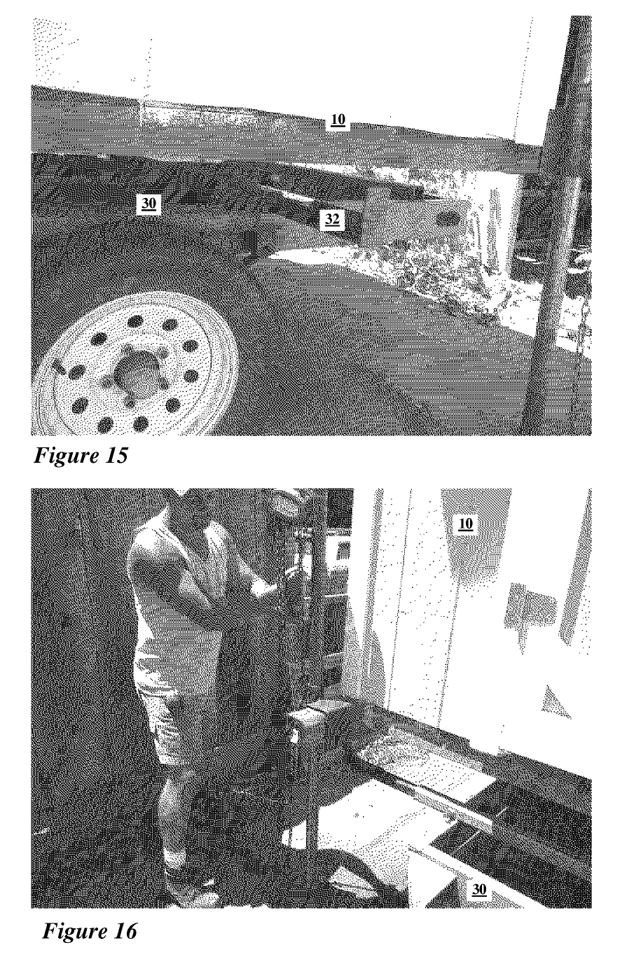

FIG. 15 shows the Shed 10 as it is ready to be lowered onto the Trailer 30. The Outriggers 32 extend a total of a few inches wider than the Shed. This allows some latitude for loading the Shed 10 within the stops.

FIG. 16 show the Shed 10 as it is being lowered onto the Trailer 30. The Shed is built with a pair of wood Skids at its base, which protrude past each corner of the Shed at floor level. The Skid Protrusions allow the Slide Collars to attach, for lifting and loading.

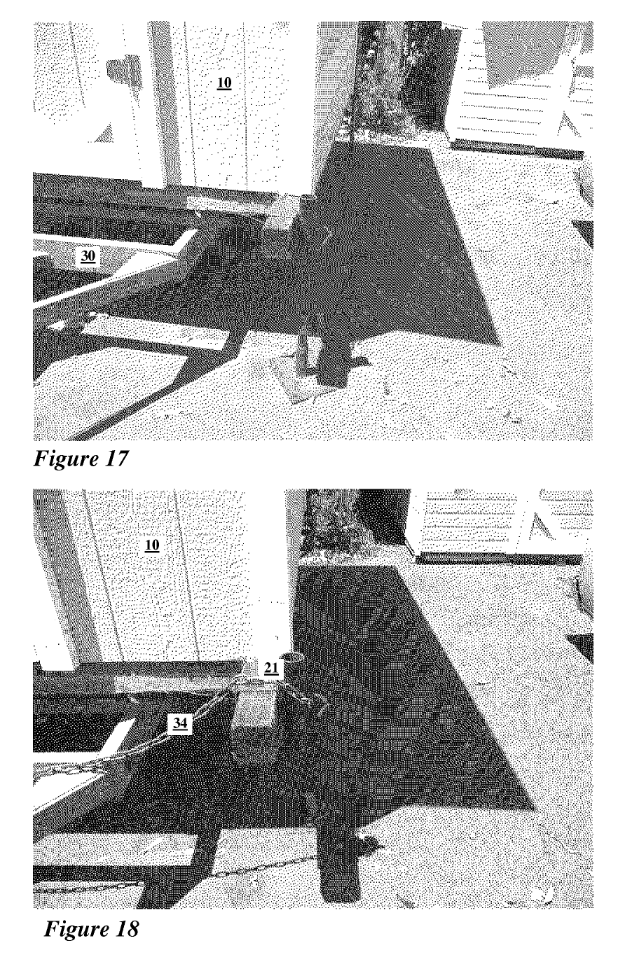

FIG. 17 shows the Shed 10 after it has been lowered onto the Trailer 30. The Hoist and Upper Segment Lift Pipe have been removed from the Jack Assembly in the foreground.

FIG. 18 shows all but the Slide Collar 21 removed from one corner of the Shed 10. A Tie-Down Chain 34 has been hooked to the Slide Collar, which stays with the shed during transport.

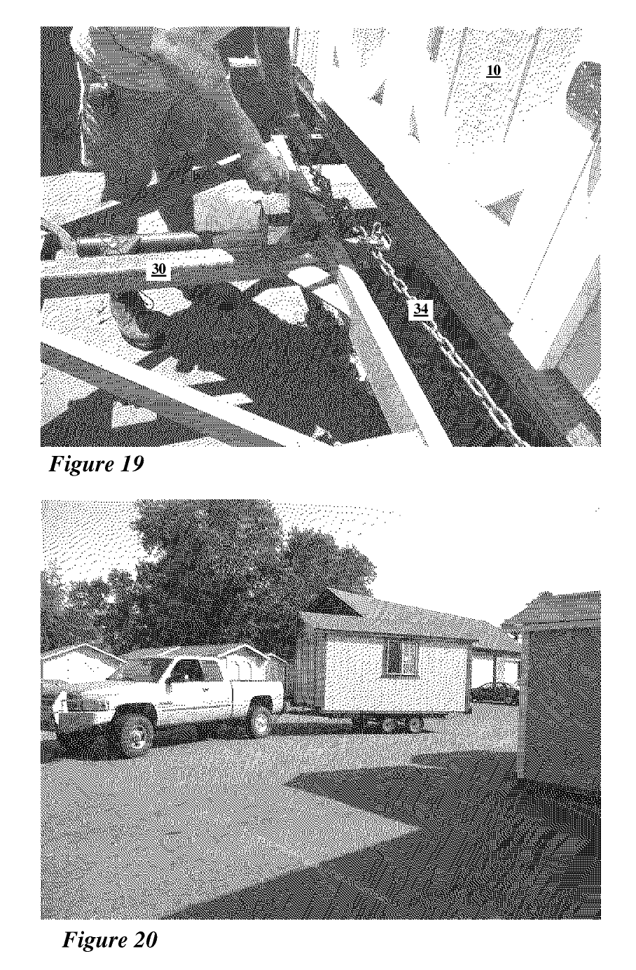

FIG. 19 shows the operator securing the front Tie-Down Chains 34 to the Trailer 30. When the rear ones are also secure, the specialized Shed 10 is ready to be hauled away safely.

FIG. 20 shows a shed being hauled away.

1. A storage shed delivery system comprising
a robust shed that is specialized to accept a set of collars as a means of lifting, leveling, and blocking,
a specialized trailer equipped with outriggers,
and a set of jack assemblies;
wherein said system allows a single operator to deliver and install a storage shed in particularly tight locations, and without slamming or sliding said shed.
